(19) United States
(12) Patent Application Publication
(10) Pub. No.: US 2018/0218305 A1
(43) Pub. Date: Aug. 2, 2018

(54) METHOD, SYSTEM AND COMPUTER PROGRAM PRODUCT FOR FACILITATING TASK AUTOMATION AT A SERVICE DESK

(71) Applicant: MOVEWORKS, INC., Fremont, CA (US)

(72) Inventors: Bhavin Nicholas SHAH, Fremont, CA (US); Vaibhav NIVARGI, Mountain View, CA (US); Vachan WODEYAR, San Jose, CA (US); Varun SINGH, San Francisco, CA (US); Jiang CHEN, Fremont, CA (US); Sadish RAVI, Fremont, CA (US)

(21) Appl. No.: 15/466,791

(22) Filed: Mar. 22, 2017

Related U.S. Application Data
(63) Continuation-in-part of application No. 15/421,339, filed on Jan. 31, 2017.

(51) Int. Cl. G06Q 10/06; G06F 21/45; G06F 21/44; G06Q 10/10; G06Q 30/00

(52) U.S. Cl. CPC G06Q 10/06316; G06F 21/45; G06Q 30/018; G06Q 10/103; G06F 21/44

(57) ABSTRACT

Method, system and computer program product for facilitating task automation at an IT service desk associated with an enterprise are disclosed. A user interface (UI) is provisioned to a user to enable the user to provide a request in a natural language form to the IT service desk. A virtual agent engages in a natural language interaction with the user on the UI and interprets the request from the natural language interaction. The request is mapped to a set of pre-determined actions based on the interpretation of the request and an execution of the set of pre-determined actions is effected to facilitate resolution of the request provided by the user.

### TECHNICAL FIELD

The present technology generally relates to assisting enterprise users and, more particularly, to a method and system for facilitating task automation at service desks associated with the enterprises for assisting enterprise users.

### BACKGROUND

Typically, enterprise users are required to fill out tickets when requesting routine access and provisioning tasks from IT service desks associated with the enterprises. Some examples of such routine access and provisioning tasks include tasks, such as adding or removing an email ID from a mailing list, seeking access to an application, resetting a password, and the like.

In many example scenarios, the tickets raised by enterprise users are held up in a queue until an agent triages them, and assigns them to the right group/person to act upon. In case of tickets being incorrectly filled or having missing information, the ticket resolution may incur even more time. In some example scenarios, the ticket resolution may involve multi-person communication, such as for seeking approvals from a manager or an administrator. In such cases, the ticket resolution may incur additional delays until each person has signed off or provided their respective confirmation. In most cases this delay could be hours or even days depending upon the workload handled by the ticket resolution system. In this duration a user is essentially blocked from executing his/her job.

In view of the above, there is a need to overcome the drawbacks of conventional Information Technology Service Management (ITSM) solutions deployed at service desks of the enterprises and facilitate automation of routine access and provisioning tasks for assisting enterprise users.

### SUMMARY

Various embodiments of the present disclosure provide a method, a system and a computer program product for facilitating task automation at an information technology (IT) service desk associated with an enterprise.

In an embodiment, a system for facilitating task automation at an IT service desk associated with an enterprise is disclosed. The system includes at least one processor and a memory having stored therein machine executable instructions, that when executed by the at least one processor, causes the system to provision a user interface (UI) to a user to enable the user to provide a request in a natural language form to the IT service desk. The system causes a virtual agent to engage in a natural language interaction with the user on the UI. The virtual agent is configured to interpret the request from the natural language interaction. The system maps the request to a set of pre-determined actions based on the interpretation of the request and effects execution of the set of pre-determined actions to facilitate resolution of the request provided by the user.

In an embodiment, a computer-implemented method for facilitating task automation at an IT service desk associated with an enterprise is disclosed. The method provisions a user interface (UI), by a processor, to a user to enable the user to provide a request in a natural language form to the IT service desk. The method causes a virtual agent to engage in a natural language interaction with the user on the UI by the processor. The virtual agent is configured to interpret the request from the natural language interaction. The method maps the request, by the processor, to a set of pre-determined actions based on the interpretation of the request. The method effects, by the processor, execution of the set of pre-determined actions to facilitate resolution of the request provided by the user.

In an embodiment, a computer program product for facilitating task automation at an IT service desk associated with an enterprise includes at least one computer-readable storage medium. The computer-readable storage medium includes a set of instructions, which, when executed by one or more processors, cause an electronic device to provision a user interface (UI) to a user to enable the user to provide a request in a natural language form to the IT service desk. The electronic device causes a virtual agent to engage in a natural language interaction with the user on the UI. The virtual agent is configured to interpret the request from the natural language interaction. The electronic device is caused to map the request to a set of pre-determined actions based on the interpretation of the request and effect execution of the set of pre-determined actions to facilitate resolution of the request provided by the user.

Other aspects and example embodiments are provided in the drawings and the detailed description that follows.

### BRIEF DESCRIPTION OF THE FIGURES

For a more complete understanding of example embodiments of the present technology, reference is now made to the following descriptions taken in connection with the accompanying drawings in which:

FIG. 1 shows a representation of a process flow associated with resolution of user requests received at an information technology (IT) service desk associated with an enterprise, in accordance with an example scenario;

FIG. 2 is a block diagram of the system configured to facilitate task automation at an IT service desk associated with an enterprise, in accordance with an example embodiment;

FIG. 3 shows a UI provisioned to a user for facilitating a natural language interaction between the user and a virtual agent, in accordance with an example embodiment;

FIG. 4A shows a UI displaying a natural language interaction between a user and a virtual agent, in accordance with another example embodiment;

FIG. 4B shows a UI displaying a natural language interaction between a virtual agent and an approver of user request, in accordance with an example embodiment;

FIG. 5 shows an example representation of a process flow for facilitating task automation at an IT service desk, in accordance with an example embodiment; and

FIG. 6 is a flow diagram of a method for facilitating task automation at a service desk associated with an enterprise, in accordance with an example embodiment.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

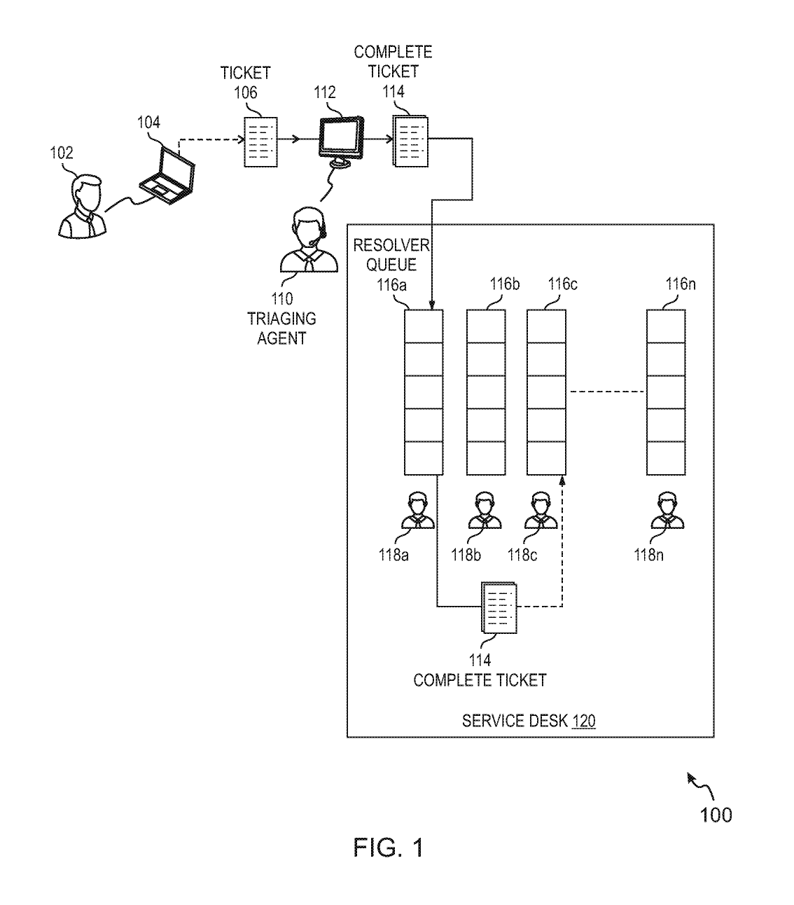

FIG. 1 shows a representation of a process flow 100 associated with resolution of user requests received at an information technology (IT) service desk associated with an enterprise, in accordance with an example scenario. The process flow 100 depicts a user 102 provisioning a request to an IT service desk 120 associated with an enterprise. The term ‘user’ as used herein refers to an employee, a contractor, or a customer associated with the enterprise. The user 102 may use a device 104 (exemplarily depicted to be a laptop computer) to connect to the IT service desk 120 (for example, by using local enterprise intranet or any such network communication means) and provide the request. It is noted that the device 104 is depicted to be a laptop computer for illustration purposes and that the user 102 may provide the request using other electronic devices, such as a desktop computer, a workstation terminal, a mobile phone, a Smartphone, a wearable device, a tablet computer, a personal digital assistant, and the like.

In an example scenario, the user 102 may require assistance from the IT service desk 120 for a variety of reasons. For example, the user 102 may require access to an application to complete an assigned task or need help in resetting a password or in some example cases may need to order a new piece of equipment, such as a laptop for instance. Typically, enterprise users are required to fill out tickets when requesting routine access and provisioning tasks from IT service desks associated with the enterprises. Accordingly, the user 102 may raise a ticket 106. The ticket 106 may include the request for assistance as provided by the user 102. The ticket 106 may be forwarded to a client device 112 associated with a triaging agent 110.

As the user 102 is usually inexperienced in filling out the ticket 106, the triaging agent 110 may often need to rectify incorrect information, guess missing information in the ticket 106 and communicate with the user 102 to receive accurate information as necessary for generating a complete ticket 114. Such a manual process of generating the complete ticket 114 is usually tedious and error prone, as the triaging agent 110 may fail in some cases to capture the request correctly due to lack of proper communication and understanding.

The complete ticket 114 may be routed by the triaging agent 110 to a resolver queue 116a from among a plurality of resolver queues 116a-n associated with the IT service desk 120. As can be seen, each resolver queue of the service desk 120 is associated with a human agent (referred to herein as a ‘resolver’) specialized to handle incidents and/or service requests of a particular domain. For example, a resolver 118a is designated to the resolver queue 116a, a resolver 118b is designated to the resolver queue 116b, a resolver 118c is designated to the resolver queue 116c and a resolver 118n is designated to the resolver queue 116n. However, in case the triaging agent 110 fails to determine an appropriate domain of the complete ticket 114, the resolver queue 116a may be inappropriate for effecting resolution of the complete ticket 114. Hence, the resolver 118a of the resolver queue 116a may further route the complete ticket 114 to a second resolver queue such as the resolver queue 116c, if the resolver 118a opines that the resolver queue 116c is an appropriate resolver queue for effecting resolution of the complete ticket 114. Such a routing process of the complete ticket 114 may continue between one or more resolver queues 116a-n, until the complete ticket 114 reaches a relevant resolver queue. As a result an overall efficiency of the IT service desk 120 in resolution of the ticket 106 is decreased due to inaccurate information provided within the ticket 106 and incorrect routing of the complete ticket 114.

In some example scenarios, the ticket resolution may involve multi-person communication, such as for seeking approvals from a manager or an administrator. In such cases, the ticket resolution may incur additional delays until each person has signed off or provided their respective confirmation. In this duration a user is essentially blocked from executing his/her job.

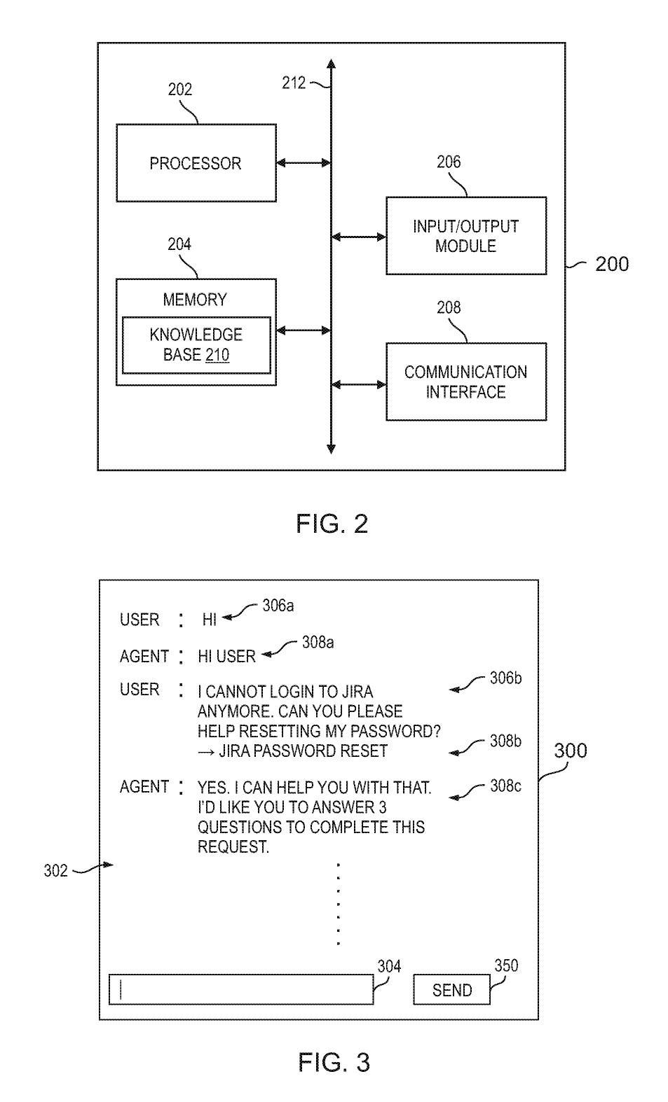

Various embodiments of the present technology provide a method, a system and a computer program product that are capable of overcoming these and other obstacles and providing additional benefits. More specifically, various embodiments of the present technology disclose techniques for facilitating task automation at IT service desks of enterprises. The techniques disclosed herein preclude the need for the user to file a ticket thereby making it easier for the users to request assistance from the IT service desks. Further, various embodiments suggest maintaining the full context of the user request, vis-à-vis who the user is, who is making the request, if an approval is required to execute the request and if so, who their manager is, and the like. As a result, the task of seeking approvals is completed in a timely manner as virtual agents are configured to directly message the approvers and get the required confirmation from the approvers. Moreover, the system as disclosed herein is configured to execute actions as well as log tickets for compliance and audit reasons. A system configured to facilitate task automation at an IT service desk associated with an enterprise is explained with reference to FIG. 2.

FIG. 2 is a block diagram of the system 200 configured to facilitate task automation at an IT service desk associated with an enterprise, in accordance with an example embodiment. The system 200 includes at least one processor such as a processor 202, at least one memory such as a memory 204, an input/output (I/O) module 206 and a communication interface 208. Although the system 202 is depicted to include only one processor 202, the system 200 may include more number of processors therein. In an embodiment, memory 204 is capable of storing platform instructions. Further, the processor 202 is capable of executing the stored platform instructions. In at least one example embodiment, the stored platform instructions include machine learning and artificial intelligence (AI) routines that may facilitate machine based interaction, for example a speech-based interaction or a chat-based interaction, with a human. More specifically, the memory 204 includes computer programs with corresponding executable instructions that, in essence, configure a virtual agent, which is capable of interacting with a human, such as for example an employee of an enterprise.

In an embodiment, the processor 202 may be embodied as a multi-core processor, a single core processor, or a combination of one or more multi-core processors and one or more single core processors. For example, the processor 202 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, and the like. In an embodiment, the processor 202 may be configured to execute hard-coded functionality. In an embodiment, the processor 202 may be embodied as an executor of software instructions, wherein the software instructions may specifically configure the processor 202 to perform algorithms and/or operations described herein when the software instructions are executed.

The memory 204 may be embodied as one or more volatile memory devices, one or more non-volatile memory devices, and/or a combination of one or more volatile memory devices and non-volatile memory devices. For example, the memory 204 may be embodied as magnetic storage devices (such as hard disk drives, floppy disks, magnetic tapes, etc.), optical magnetic storage devices (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash ROM, RAM (random access memory), etc.).

The memory 204 includes a knowledge base, such as a knowledge base 210. The knowledge base 210 serves as a store of user requests that are anticipated at the IT service desk of the enterprise. The user requests are stored along with corresponding set of actions to be performed for resolving the user requests. More specifically, the processor 202 is configured to learn from past tickets and past requests of enterprise users and associate actions with user requests. For example, if a user request corresponds to adding a user's email ID to a marketing group mailing list, then actions to be performed for resolving such a request may be learnt from previous actions of resolvers or human agents and stored in the knowledge base 210. In an illustrative example, the set of actions for such a request may involve requesting access from an administrator of the marketing group mailing list, providing user credentials as a part of the access request, adding the user's email ID to the marketing group mailing list upon receiving the approval from the administrator and the notifying the user thereafter.

In an embodiment, each user request may be stored along with a set of pre-determined actions to be performed in the knowledge base 210. In at least one example embodiment, the user requests are tagged with keywords and other such metadata to facilitate ease of retrieval from the knowledge base 210. The user requests and the corresponding set of pre-determined actions and keywords together configure the information stored in the knowledge base 210, and this information is constantly updated/fine-tuned based on observed real-time usage behavior of users of the enterprise.

In at least one example embodiment, the processor 202 may be configured to communicate, using the communication interface 208, with public data sources (for example, sources like Wikipedia™, technical community forums, etc.) and private data sources (for example, online technical libraries) to augment information stored in the knowledge base 210. Accordingly, multiple forms of making a request are stored for each type of user concern, in the knowledge base 210. In an embodiment, the information stored in the knowledge base 210 configures a knowledge graph including a network of interconnected nodes and branches. The knowledge graph may be systematically pruned to match a user request to a stored user request as will be explained in detail later.

The I/O module 206 is configured to facilitate provisioning of an output to a user of the system 200 and/or for receiving an input from the user of the system 200. The I/O module 206 is configured to be in communication with processor 202 and memory 204. Examples of the I/O module 206 include, but are not limited to, an input interface and/or an output interface. Some examples of the input interface may include, but are not limited to, a keyboard, a mouse, a joystick, a keypad, a touch screen, soft keys, a microphone, and the like. Some examples of the output interface may include, but are not limited to, a microphone, a speaker, a ringer, a vibrator, a light emitting diode display, a thin-film transistor (TFT) display, a liquid crystal display, an active-matrix organic light-emitting diode (AMOLED) display, and the like. In an example embodiment, the processor 202 may include I/O circuitry configured to control at least some functions of one or more elements of I/O module 206, such as, for example, a speaker, a microphone, a display, and/or the like. The processor 202 and/or the I/O circuitry may be configured to control one or more functions of the one or more elements of the I/O module 206 through computer program instructions, for example, software and/or firmware, stored on a memory, for example, the memory 204, and/or the like, accessible to the processor 202.

The communication interface 208 enables the system 200 to communicate with other entities over various types of wired, wireless or combinations of wired and wireless networks, such as for example, the Internet. In at least one example embodiment, the communication interface 208 includes a transceiver circuitry configured to enable transmission and reception of data signals over the various types of communication networks. In some embodiments, the communication interface 208 may include appropriate data compression and encoding mechanisms for securely transmitting and receiving data over the communication networks. The communication interface 208 facilitates communication between the system 200 and servers hosting the IT service desk, servers hosting the enterprise website, public data sources, private data sources, electronic devices associated with the users, electronic devices associated with the human agents, and the like.

In an example embodiment, the communication interface 208 is capable of facilitating communication between the processor 202 of the system 200 and servers hosting service applications/databases like Okta™, Google Groups™, Salesforce™ Expensify™, and the like to facilitate execution of user requests. To that effect, the communication interface 208 may include relevant Application Programming Interfaces (APIs) to facilitate communication between the processor 202 and the servers hosting such applications/databases. For example, the communication interface 208 may enable using API calls using Representational State Transfer (REST) protocol or Simple Object Access Protocol (SOAP), to facilitate communication between the processor 202 and the servers hosting such service applications/databases. In some embodiments, the communication interface 208 is also capable of facilitating communication between the processor 202 of the system 200 and various resolver queues associated with the IT service desk of the enterprise, such as the resolver queues 116a-n explained with reference to FIG. 1.

Further, the communication interface 208 may be configured to effect a display of a user interface (UI), such as for example a chat application UI or a voice-application UI, on a device associated with a user of the enterprise. The UI is configured to facilitate a natural language interaction between a user and a virtual agent. The communication interface 208 may also serve to receive inputs provided to the UI by the user and relay responses from the virtual agent to the user using the UI. The communication interface 208 may include relevant messaging application APIs to facilitate a UI-based interaction between the user and the virtual agent.

In an embodiment, various components of the system 200, such as the processor 202, the memory 204, the I/O module 206 and the communication interface 208 may be configured to communicate with each other via or through a centralized circuit system 212. The centralized circuit system 212 may be various devices configured to, among other things, provide or enable communication between the components (202-208) of the system 200. In certain embodiments, the centralized circuit system 210 may be a central printed circuit board (PCB) such as a motherboard, a main board, a system board, or a logic board. The centralized circuit system 210 may also, or alternatively, include other printed circuit assemblies (PCAs) or communication channel media.

The system 200 as illustrated and hereinafter described is merely illustrative of a system that could benefit from embodiments of the invention and, therefore, should not be taken to limit the scope of the invention. In at least one example embodiment, the system 200 may be deployed in an electronic device, such as an enterprise server associated with an IT service desk of the enterprise. The service desk, as described herein, is implemented as an operator-less system capable of assisting enterprise users with their respective requests. It is noted that the service desk is capable of performing several other functions in addition to assisting users with request resolutions. For example, the service desk may assign human agents to physical tasks like hardware deployment, software installation, network maintenance, and the like. The system 200 may be configured to be in operative communication with such a service desk to facilitate resolution of requests from the enterprise users. It is noted that the system 200 may include fewer or more components than those depicted in FIG. 2. As explained above, the system 200 may be included within or embody an electronic device. Moreover, the system 200 may be implemented as a centralized system, or, alternatively, the various components of system 200 may be deployed in a distributed manner while being operatively coupled to each other.

The facilitating of task automation by the system 200 is explained hereinafter with reference to a single request from an enterprise user. It is noted that the system 200 may be configured to facilitate task automation of several types of provisioning and access requests from a plurality of enterprise users.

In at least one example embodiment, the processor 202 is configured to, with the content of the memory 204, cause the system 200 to provision a user interface (UI) to a user to enable the user to provide a request in a natural language form to the IT service desk. In many example scenarios, the user may need access to an application or need assistance from the IT service desk and may attempt to connect with an IT service desk associated with the enterprise. As explained above, the term ‘IT service desk’ refers to a single point of contact between users and Information Technology Service Management (ITSM) of the enterprise. In an example embodiment, the service desk may include a call center or an IT help desk supported by human and virtual agents. As explained above, the term ‘user’ may refer to an employee, a contractor, a customer or any such individual, who may approach the IT service desk for assistance. The term ‘request’ as used herein refers to a formal request made by a user of the enterprise for certain services, software or hardware that the user may need. An example of a service request may include request for login access to a local printer installed within the enterprise. Some other non-exhaustive examples of requests may include seeking approval for accessing an application, a password reset request, seeking access to a shared folder, ordering an equipment or an item, seeking membership to an enterprise group, requesting addition of an email to a group mailing list or removal of the email from the group mailing list, and the like. The term ‘resolution of requests’ as used herein refers to providing a satisfactory solution to the requests from the users.

In an illustrative example, a user may need to file expenses and may not have access to the expense reporting application ‘Expensify™’. Upon trying to login, the user may get an ‘Access Denied’ message. In such a scenario, the user may wish to connect with the IT service desk to resolve the issue and obtain access to the application. Accordingly, the user may click on the Help section displayed on the intranet portal or may provide a click or a touch input on a hyperlink or a widget displayed on the enterprise website, to seek assistance from the IT service desk. Such an input may be captured, for example through Hypertext Markup Language (HTML) tags or JavaScript tags embedded on the intranet portal or the enterprise Website. The recorded input may be received by the communication interface 208 from the server hosting the IT service desk (or from the server hosting the intranet portal or the enterprise website). The communication interface 208 may provision the input to the processor 202, which may be configured to provision a UI capable of facilitating a natural language interaction between the user seeking assistance and a virtual agent.

In an example embodiment, the UI may be configured to facilitate a chat interaction. Accordingly, in such a scenario, the UI may correspond to an instant messaging application UI. In another example embodiment, the UI may correspond to facilitate a voice interaction (such as for example, voice-over-IP (VOIP) call) and accordingly, the UI may correspond to VOIP application UI. In another example embodiment, the UI may correspond to a display-based interactive voice response (IVR) UI. The user may provide one or more requests in natural language form using the UI. For example, the user may provide a request in natural language form as ‘I need access to the sales dashboard’, or ‘I have changed teams recently and need access to the marketing email list’, or Van you help resetting my password?′, and the like.

In at least one example embodiment, the processor 202 is configured to, with the content of the memory 204, cause the system 200 to cause a virtual agent to engage in a natural language interaction with the user on the UI. As explained above, the memory 204 stores computer programs, which in effect, configures a virtual agent (i.e. a virtual assistant) capable of conducting a machine-based interaction with a human. The virtual agent may be invoked upon provisioning of the UI to the user. The virtual agent may be configured to engage in a natural language interaction with the user to facilitate interpretation of the user request. In an embodiment, the interpretation of the request from the natural language interaction may be performed based on learning from previously generated tickets and past natural language interactions of enterprise users availing assistance from the IT service desk. To that effect, the memory 204 of the system 200 may include machine learning algorithms and artificial intelligence (AI) routines capable of facilitating learning from responses provided to the user requests, their outcomes, past tickets, frequently asked questions by users, and the like. The virtual agent may be configured to leverage such machine learning (ML) capabilities and use natural language processing (NLP) to engage in interactions with the users. Furthermore, the virtual agent may also be caused to leverage unstructured or ‘private’ data—from external knowledge databases (such as Wikipedia for instance), online question-answer forums, run books and past chat transcripts to achieve an accurate interpretation of the request.

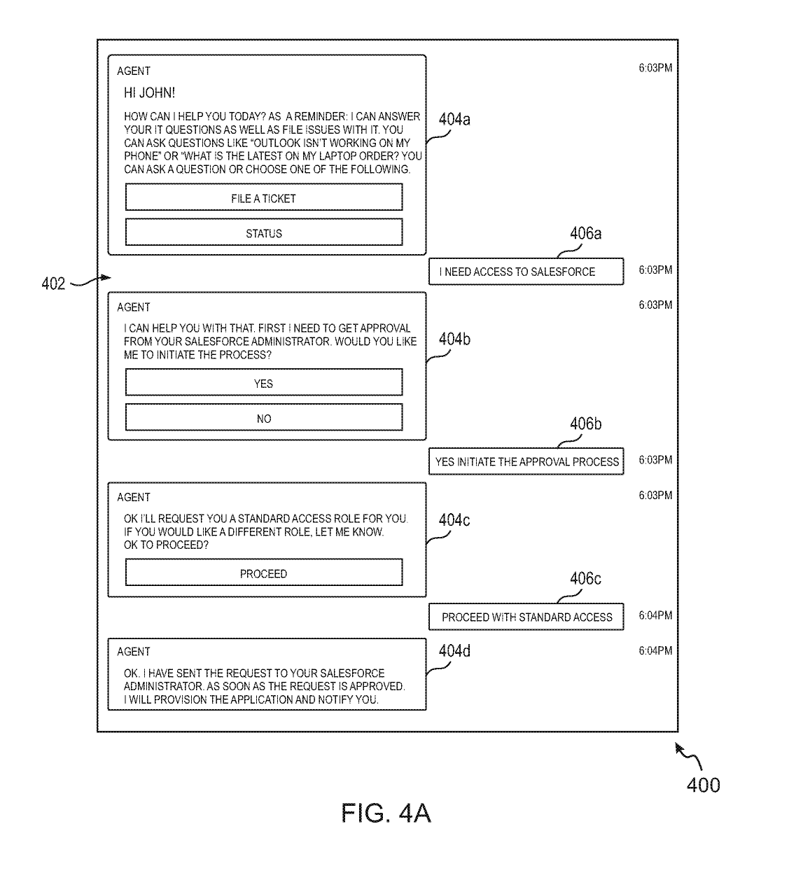

An example natural language based interaction between the user and the agent is depicted in FIG. 3.

Referring now to FIG. 3, a UI 300 provisioned to a user for facilitating a natural language interaction 302 between a user and a virtual agent is shown, in accordance with an example embodiment. The UI 300 may be displayed on a display screen of an electronic device associated with the user. Some non-limiting examples of such an electronic device include a workstation terminal, a desktop computer, a laptop, a smartphone, a tablet computer, a wearable device, and the like. As explained with reference to FIG. 2, the system 200 may provision a UI to a user seeking assistance from an IT service desk associated with an enterprise. The UI 300 is depicted as a chat application UI for illustration purposes. It is noted that in some embodiments, the UI 300 may be embodied as a VOIP application UI configured to facilitate voice/video-based interaction with a virtual agent. In some embodiments, the UI may also correspond to a Short Messaging Service (SMS) or an Email based UI.

The UI 300 is depicted to facilitate a natural language interaction 302 (hereinafter referred to as chat interaction 302) between the user and the virtual agent. In the chat interaction 302, the interaction entries provided by the user are exemplarily tagged with label ‘USER’, whereas the interaction entries provided by the virtual agent are exemplarily tagged with label ‘AGENT’. It is noted that such tags are mentioned herein for illustration purpose. Indeed, the interaction lines in the chat interaction 302 may be tagged with respective names, employee IDs, usernames of the user and the virtual agent, respectively.

The UI 300 further depicts a dialog box 304 to facilitate provisioning of a text input by the user, such as an input message 306a and a request 306b during the interaction. The user may provide the input using a physical keyboard, a virtual keyboard, speech-recognition aid, and the like. The dialog box 304 further includes a send button 350, which may be configured to initiate transmission of a completed input to the chat recipient. The virtual agent may respond to the user inputs by displaying a corresponding output message below the associated user input within the UI 300. For example, when the user provides the input message 306a, for example “Hi”, the virtual agent may respond with a corresponding output message 308a, exemplarily depicted as “Hi user” for instance. Similarly, when the user inputs the request 306b, i.e. “I cannot login to Jira anymore. Can you help resetting my password?’, the virtual agent may interpret the request as ‘Jira Password Reset’ (as depicted by machine interpretation 308b) using machine-learning based on past tickets with similar pattern, and respond with a corresponding output message 308c. It is noted that different users may provision several types of request in natural language form to the virtual agent and the virtual agent may be configured to engage in natural language interactions, such as the chat interaction 302, with the users and interpret the request from the respective natural language interactions.

Referring now to FIG. 2, in at least one example embodiment, the processor 202 is configured to, with the content of the memory 204, cause the system 200 to map the request to a set of pre-determined actions based on the interpretation of the request. The mapping of the request to the set of pre-determined actions may be performed based on learning from previously generated tickets and past natural language interactions of enterprise users availing assistance from the IT service desk. As explained above, the knowledge base 210 in the memory 204 may store user requests anticipated at the IT service desk along with corresponding actions performed to resolve the request. Some non-exhaustive examples of user requests stored in the knowledge base 210 may include requests for seeking approval for accessing an application, for resetting a password reset, for seeking access to a shared folder, for ordering an equipment (such as a keyboard, a laptop, etc.) or an item (such as a business card, a desk calendar etc.), for seeking membership to an enterprise group, for requesting addition of an email to a group mailing list or removal of the email from the group mailing list, and the like. Each stored request may be associated with tags, such as for example keyword tags like ‘Password Reset’, ‘Access Google Groups’, and the like, in the knowledge base 210. Accordingly, upon receiving a user request on the UI, the processor 202 may be configured to compare the words or combination of words (for example, unigrams, bi-grams, n-grams or phrases) in the user request with the tags associated with stored requests to identify a match. A match between a tag and the user request may be indicative of an overlap of content or interest between the user request and stored request in the knowledge base 210. The processor 202 may then be configured to fetch the set of actions stored along with the stored user request. The fetched actions may configure the set of pre-determined actions to be performed for resolving the user request. In an illustrative example, the set of pre-determined actions for a user request related to resetting a password may include, authenticating a credentials of the user, communicating with the relevant application for resetting the password, obtaining a URL for setting the password and provisioning the URL to the user to enable the user to change the password.

In at least one example embodiment, the processor 202 is configured to, with the content of the memory 204, cause the system 200 to effect execution of the set of pre-determined actions to facilitate resolution of the request provided by the user. To that effect, the processor 202 of the system 200 may be configured to connect with one or more service applications to effect automatic execution of the set of pre-determined actions. In an illustrative example, the processor 202 may be configured to connect to the servers hosting relevant service applications such as Google Groups™, Microsoft AD™, Okta™, among others to perform various actions. In some cases, this may involve making specific API calls (REST or Soap) by the communication interface 208, and in other instances it may involve making modifications to a database. In an illustrative example, the processor 202 may be configured to connect to a service such as Okta™ or Active Directory™ and perform actions, such as add or remove a user from a group and thereafter notify the user. In another illustrative example, the processor 202 may be configured to connect to Software-as-a-service (SAAS) application and create an account for a user. In yet another illustrative example, the processor 202 may be configured to connect to a storage service such as Box™ or Dropbox™ and modify permissions of a folder to allow a user (or group) access to some resource. In some embodiments, the processor 202 may also be configured to connect to a server and perform an action on the local system, such as start/stop a service or modify a file/directory. In effect, the processor 202 may be configured to communicate with servers hosting service applications/databases in the enterprise environment and fetch instructions (actions) to perform on infrastructure accessible to it. In an embodiment, the system 200 is caused to log an entry corresponding to each executed action for meeting at least one of compliance and audit requirements. In at least one example embodiment, the entries may be logged in form of tickets.

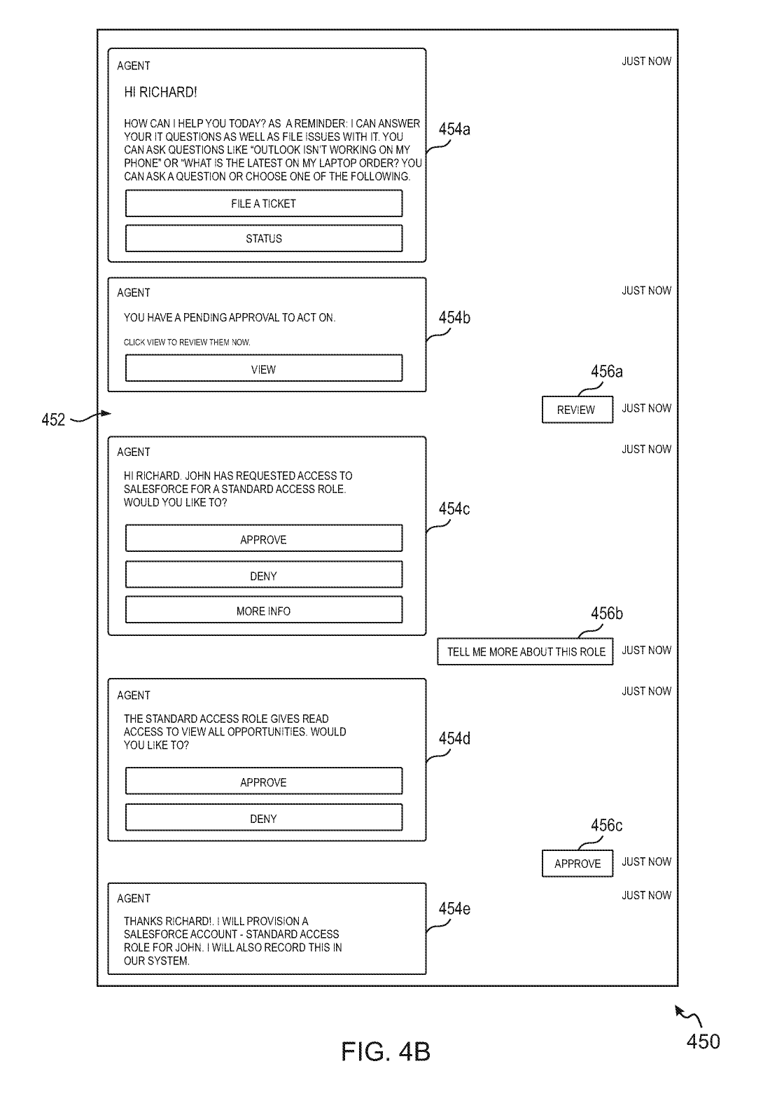

In some example scenarios, resolving a user request may require seeking approval from relevant personnel, such as a manager of the user, a network administrator, and the like. To that effect, in at least one example embodiment, the processor 202 of the system may be configured to determine a context associated with the request. The determination of the context may include determining at least one of an identity of the user, whether one or more approvals are required for resolving the user request, and the identity of at least one approver if it is determined that one or more approvals are required for resolving the user request. Subsequent to determining the context of the request, the processor 202 may be configured to cause the virtual agent to interact with the at least one approver to seek the one or more approvals if it is determined that one or more approvals are required for resolving the user request. In addition to providing the user request to the approver for approval, the virtual agent may also provide the context of the request by the approver(s). The automation of resolution of user requests requiring approval from an administrator is explained with reference to FIGS. 4A and 4B.

Referring now to FIG. 4A, a UI 400 displaying a natural language interaction 402 between a user and a virtual agent is shown, in accordance with an example embodiment. The UI 400 is similar to UI 300 and is not explained again herein. In the chat interaction 402, the interaction entries provided by the virtual agent are exemplarily tagged with label ‘Agent’. The interaction entries by the user ‘John’ are not explicitly tagged in the UI 400. As can be seen from the chat interaction 402, the UI 400 provisioned to the user includes a greeting message 404a. The user may respond with a request 406a exemplarily depicted to be ‘I need access to Salesforce’. The processor 202 may be configured to determine the context of such a request. More specifically, the processor 202 may determine the identity of the user ‘John’ and whether the request from John requires approval from an approver and if yes, then determine the identity of the approver. In an example scenario, the processor 202 may determine that request needs to be approved by a Salesforce administrator ‘Richard’. Accordingly, the agent may respond with a message 404b. Upon receiving a confirmation from the user (via message 406b), the agent may ask the user for a type of access desired by the user (via message 404c). The user may indicate his choice of access as exemplarily depicted in response 406c. The agent may then be caused to confirm the receipt of the type of access as exemplarily depicted using message 404d.

As explained above, upon determining the identity of the approver, the processor 202 may cause the virtual agent to directly interact with the approver for seeking approval related to the user request. Such an interaction is depicted in FIG. 4B.

Referring now to FIG. 4B, a UI 450 displaying a natural language interaction 452 between a virtual agent and an approver is shown, in accordance with an example embodiment. The UI 450 is similar to UI 300 and is not explained again herein. In the chat interaction 452, the interaction entries provided by the virtual agent are exemplarily tagged with label ‘Agent’. The interaction entries by the approver ‘Richard’ are not explicitly tagged in the UI 450. As can be seen from the chat interaction 452, the UI 450 provisioned to the user includes a greeting message 454a. The agent may further remind the user ‘Richard’ that he has a request to review and act upon, as exemplarily depicted using message 454b. The user may seek to view the approval request and thereafter the agent may display the request to the user, as exemplarily depicted using messages 456a and 454c, respectively. The user may also seek additional information (for example, context of the request) from the agent as exemplarily depicted using message 456b. The agent may display the additional information regarding the request and seek Richard's approval and the approver ‘Richard’ may approve the user John's request, as exemplarily depicted using messages 454d and 456c, respectively. The agent may then be configured to thank the approver and confirm the approval of the user's request as exemplarily depicted using message 454e. The user ‘John’ may then be notified of the approval and thereafter required access to Salesforce may be provisioned to the user ‘John’. As can be seen from the example explained with reference to FIGS. 4A and 4B, the system 200 is configured to facilitate automation of task of resolution of user requests and moreover the user is sparred the cumbersome effort of raising tickets, seeking necessary approvals and waiting for approval to complete a job at hand.

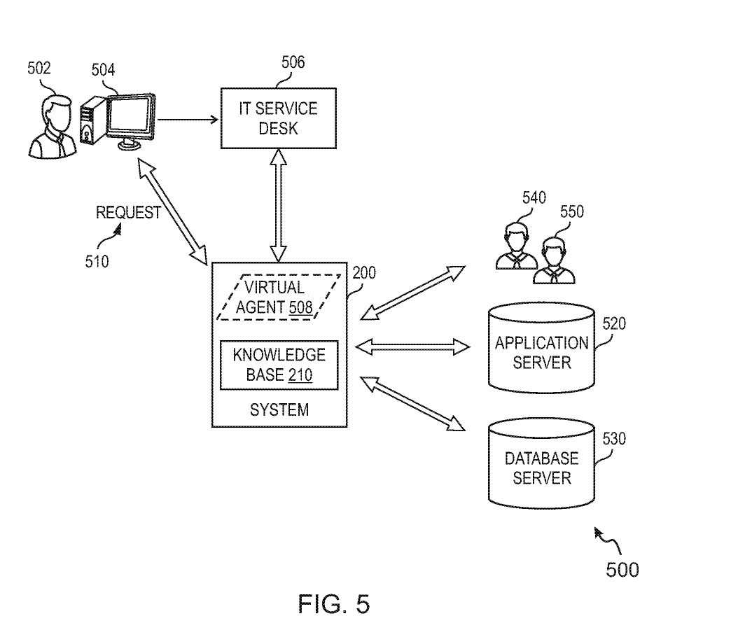

A process flow for facilitating task automation at an IT service desk is explained next with reference to FIG. 5.

FIG. 5 shows an example representation of a process flow 500 for facilitating task automation at an IT service desk, in accordance with an example embodiment. The process flow 500 depicts a user 502 associated with a workstation terminal 504. In an example scenario, the user 502 may wish to seek assistance from an IT service desk and accordingly may contact the service desk 506. The system 200 on account of being communicably associated with the service desk 506 may receive the input corresponding to the desired assistance and provision a UI, such as the UI 300 explained with reference to FIG. 3, to the user 502. The user 502 may provide a request 510 using the UI displayed on the workstation terminal 504. The system 200 may cause a virtual agent 508 to engage in an interaction (for example, a natural language interaction such as interactions 302 or 402) with the user 502 to interpret the request 510 and map the request 510 to a set of pre-determined actions. The system 200 may further be caused to effect execution of the actions to facilitate resolution of the request. As explained with reference to FIG. 2, the system 200 may be caused to connect to servers hosting service applications and databases, as exemplarily depicted by an application server 520 and a database server 530 to facilitate resolution of user requests. In some scenarios where the user request needs to be approved by one or more approvers, the virtual agent 508 may be configured to directly communicate with the relevant approvers (exemplarily depicted by approvers 540 and 550) for obtaining the desired approvals and facilitating resolution of user requests.

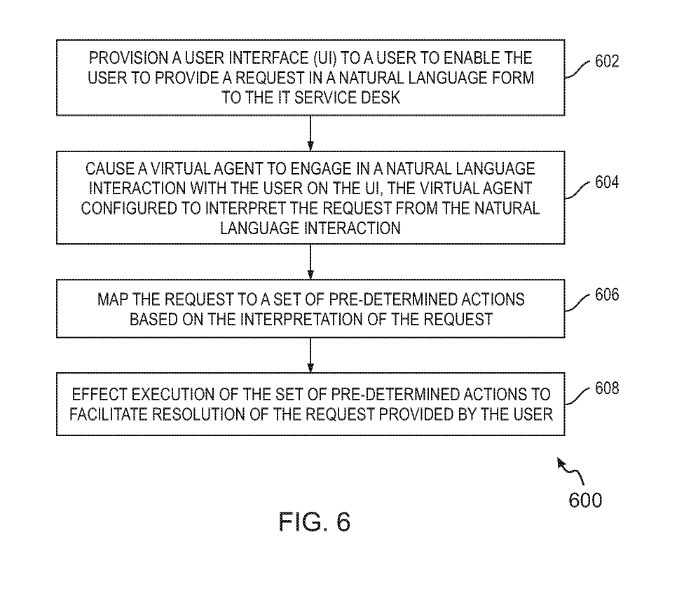

FIG. 6 is a flow diagram of a method 600 for facilitating task automation at an IT service desk associated with an enterprise, in accordance with an example embodiment. The method 600, depicted in the flow diagram may be executed by, for example, the system 200 explained with reference to FIGS. 2-5. Operations of the flowchart, and combinations of operation in the flowchart, may be implemented by, for example, hardware, firmware, a processor, circuitry, and/or a different device associated with the execution of software that includes one or more computer program instructions for resolution of queries submitted by one or more users. The operations of the method 600 are described herein with help of the system 200. For example, one or more operations corresponding to the method 600 may be executed by a processor, such as the processor 202 of the system 200. It is noted that although the one or more operations are explained herein to be executed by the processor alone, it is understood that the processor is associated with a memory, such as the memory 204 of the system 200, which is configured to store machine executable instructions for facilitating the execution of the one or more operations. It is also noted that, the operations of the method 600 can be described and/or practiced by using a system other than the system 200. The method 600 starts at operation 602.

At operation 602 of the method 600, a user interface (UI) is provisioned to a user to enable the user to provide a request in a natural language form to the IT service desk. As explained with reference to FIG. 2, the term ‘service desk’ refers to a single point of contact between users and Information Technology Service Management (ITSM) of the enterprise. In an example embodiment, the service desk may include a call center or an IT help desk supported by human and virtual agents. As explained above, the term ‘user’ may refer to an employee, a contractor, a customer or any such individual, who may approach the service desk for assistance. The term ‘request’ as used herein refers formal request made by a user of the enterprise for certain services, software or hardware that the user may need.

The UI, such as the UI 302, may be provisioned to the user by the processor, such as the processor 202 of the system 200, to provide a request in the natural language form. Some non-exhaustive examples of user requests may include requests for seeking approval for accessing an application, for resetting a password, for seeking access to a shared folder, for ordering an equipment (such as a keyboard, a laptop, etc.) or an item (such as a business card, a desk calendar etc.), for seeking membership to an enterprise group, for requesting addition of an email to a group mailing list or removal of the email from the group mailing list, and the like.

At operation 604 of the method 600, a virtual agent may be caused to engage in a natural language interaction with the user on the UI by the processor. The virtual agent may be configured to interpret the request from the natural language interaction. At operation 606 of the method 600, the user request may be mapped to a set of pre-determined actions based on the interpretation of the request. The interpretation of the user request and the mapping of the request to the set of pre-determined actions may be performed based on learning from responses provided to the user requests, their outcomes, past tickets, frequently asked questions by users, and the like. The virtual agent may be configured to leverage such machine learning (ML) capabilities and use natural language processing (NLP) to engage in interactions with the users. Furthermore, the virtual agent may also be caused to leverage unstructured or ‘private’ data—from external knowledge databases (such as Wikipedia for instance), online question-answer forums, run books and past chat transcripts to achieve accurate interpretation of user requests.

At operation 608 of the method 600, execution of the set of pre-determined actions is effected to facilitate resolution of the request provided by the user. In some embodiments, the processor may be configured to connect with one or more applications to effect automatic execution of the set of pre-determined actions. In an illustrative example, the processor may be configured to connect to the servers hosting relevant service applications such as Google Groups™, Microsoft AD™, Okta™, among others to perform various actions. In some cases, this may involve making specific API calls (REST or Soap), and in other instances it may involve making modifications to a database. The effecting of execution of actions may be performed as explained with reference to FIG. 2 and is not explained again herein. In an embodiment, an entry corresponding to each executed action may be logged for meeting at least one of compliance and audit requirements. In at least one example embodiment, the entries may be logged in form of tickets.

In some example scenarios, resolving a user request may require seeking approval from relevant personnel, such as a manager of the user, a network administrator, and the like. To that effect, in at least one example embodiment, the processor may be configured to determine a context associated with the request. The determination of the context may include determining at least one of an identity of the user, whether one or more approvals are required for resolving the user request, and identity of at least one approver if it is determined that one or more approvals are required for resolving the user request. Subsequent to determining the context of the request, the processor may be configured to cause the virtual agent to interact with the at least one approver to seek the one or more approvals if it is determined that one or more approvals are required for resolving the user request. In addition to providing the user request to the approver for approval, the virtual agent may also provide the context of the request by the approver(s). The seeking of approval for a user request may be automated as explained with reference to FIGS. 4A and 4B and is not explained again herein.

Various embodiments of the present technology provide a method, system and computer program product that are capable of overcoming drawbacks of conventional ITSM solutions deployed at an IT service desk and providing additional benefits. More specifically, various embodiments of the present technology facilitate task automation at IT service desks. The techniques disclosed herein preclude the need for the user to file a ticket thereby making it easier for the users to request assistance from the IT service desks. Further, various embodiments suggest maintaining the full context of the user request, vis-à-vis who the user is, who is making the request, if an approval is required to execute the request and if so, who their manager is, and the like. As a result, the task of seeking approvals is rendered easy as virtual agents are configured to directly message the approvers and get the required confirmation from the approvers. Moreover, the system as disclosed herein is configured to execute actions as well as log tickets for compliance reasons for facilitating task automation.

The disclosed method 600 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer embedded in a device, such as a laptop computer, net book, web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The embodiments illustrated and described herein as well as embodiments not specifically described herein but within the scope of aspects of the invention constitute exemplary system means for facilitating resolution of task automation at an IT service desk. For example, the elements illustrated and described with reference to FIGS. 2 to 5, when configured, under control of the processor 202 and computer program code in the memory 204 to perform the operations illustrated and described with reference to FIGS. 2 to 5, constitute means for provisioning a user interface (UI) to a user to enable the user to provide a request in a natural language form to the IT service desk; means for causing a virtual agent to engage in a natural language interaction with the user on the UI, the virtual agent configured to interpret the request from the natural language interaction; means for mapping the request to a set of pre-determined actions based on the interpretation of the request; and means for executing the set of pre-determined actions to facilitate resolution of the request provided by the user.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the systems and methods may be embodied using transistors, logic gates, and electrical circuits (for example, application specific integrated circuit (ASIC) circuitry and/or in Digital Signal Processor (DSP) circuitry).

Particularly, the system 200, the processor 202, the memory 204, the I/O module 206 and the communication interface 208 may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations (for example, operations explained herein with reference to FIG. 6). A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Various embodiments of the invention, as discussed above, may be practiced with steps and/or operations in a different order, and/or with hardware elements in configurations, which are different than those which, are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A system for facilitating task automation at an information technology (IT) service desk associated with an enterprise, the system comprising:
at least one processor; and
a memory having stored therein machine executable instructions, that when executed by the at least one processor, cause the system to:
provision a user interface (UI) to a user to enable the user to provide a request in a natural language form to the IT service desk;
cause a virtual agent to engage in a natural language interaction with the user on the UI, the virtual agent configured to interpret the request from the natural language interaction;
map the request to a set of pre-determined actions based on the interpretation of the request; and
effect execution of the set of pre-determined actions to facilitate resolution of the request provided by the user.

2. The system as claimed in claim 1, wherein at least one of the interpreting of the request and the mapping of the request to the set of pre-determined actions is performed based on learning from previously generated tickets and past natural language interactions of enterprise users availing assistance from the IT service desk.

3. The system as claimed in claim 1, wherein the system is further caused to:
determine a context associated with the request, wherein the determination of the context comprises determining at least one of:
an identity of the user,
whether one or more approvals are required for resolving the user request, and
identity of at least one approver if it is determined that one or more approvals are required for resolving the user request.

4. The system as claimed in claim 3, wherein the system is further caused to:
cause the virtual agent to interact with the at least one approver to seek the one or more approvals if it is determined that one or more approvals are required for resolving the user request, wherein the at least one approver is provided the context of the request by the virtual agent.

5. The system as claimed in claim 1, wherein the system is further caused to:
connect with one or more service applications to effect automatic execution of the set of pre-determined actions, wherein each action is executed by the system or a service application from among the one or more service applications for facilitating resolution of the user request.

6. The system as claimed in claim 5, wherein the system is further caused to:
log an entry corresponding to each executed action for meeting at least one of compliance and audit requirements.

7. The system as claimed in claim 1, wherein the request from the user corresponds to one of seeking approval for accessing an application, a password reset request, seeking access to a shared folder, ordering an equipment or an item, seeking membership to an enterprise group, and requesting addition of an email to a group mailing list or removal of the email from the group mailing list.

8. The system as claimed in claim 1, wherein the UI corresponds to a chat application UI or a messaging based interface.

9. A computer-implemented method for facilitating task automation at an information technology (IT) service desk associated with an enterprise, the method comprising:
provisioning a user interface (UI), by a processor, to a user to enable the user to provide a request in a natural language form to the IT service desk;
causing a virtual agent to engage in a natural language interaction with the user on the UI by the processor, the virtual agent configured to interpret the request from the natural language interaction;
mapping the request, by the processor, to a set of pre-determined actions based on the interpretation of the request; and
effecting, by the processor, execution of the set of pre-determined actions to facilitate resolution of the request provided by the user.

10. The method as claimed in claim 9, wherein at least one of the interpreting of the request and the mapping of the request to the set of pre-determined actions is performed based on learning from previously generated tickets and past natural language interactions of enterprise users availing assistance from the IT service desk.

11. The method as claimed in claim 9, further comprising:
determining, by the processor, a context associated with the request, wherein the determination of the context comprises determining at least one of:
an identity of the user,
whether one or more approvals are required for resolving the user request, and
identity of at least one approver if it is determined that one or more approvals are required for resolving the user request.

12. The method as claimed in claim 11, further comprising:
causing the virtual agent, by the processor, to interact with the at least one approver to seek the one or more approvals if it is determined that one or more approvals are required for resolving the user request, wherein the at least one approver is provided the context of the request by the virtual agent.

13. The method as claimed in claim 9, further comprising:
connecting with one or more service applications by the processor to effect automatic execution of the set of pre-determined actions, wherein each action is executed by the system or a service application from among the one or more service applications for facilitating resolution of the user request.

14. The method as claimed in claim 13, further comprising:
logging, by the processor, an entry corresponding to each executed action for meeting at least one of compliance and audit requirements.

15. The method as claimed in claim 9, wherein the request from the user corresponds to one of seeking approval for accessing an application, a password reset request, seeking access to a shared folder, ordering an equipment or an item, seeking membership to an enterprise group, and requesting addition of an email to a group mailing list or removal of the email from the group mailing list.

16. A computer program product comprising at least one computer-readable storage medium, the computer-readable storage medium comprising a set of instructions which, when executed by one or more processors, cause an electronic device to:
provision a user interface (UI) to a user to enable the user to provide a request in a natural language form to the IT service desk;
cause a virtual agent to engage in a natural language interaction with the user on the UI, the virtual agent configured to interpret the request from the natural language interaction;
map the request to a set of pre-determined actions based on the interpretation of the request; and
effect execution of the set of pre-determined actions to facilitate resolution of the request provided by the user.

17. The computer program product as claimed in claim 16, wherein at least one of the interpreting of the request and the mapping of the request to the set of pre-determined actions is performed based on learning from previously generated tickets and past natural language interactions of enterprise users availing assistance from the IT service desk.

18. The computer program product as claimed in claim 16, wherein the electronic device is further caused to:
determine a context associated with the request, wherein the determination of the context comprises determining at least one of:
an identity of the user,
whether one or more approvals are required for resolving the user request, and
identity of at least one approver if it is determined that one or more approvals are required for resolving the user request.

19. The computer program product as claimed in claim 18, wherein the electronic device is further caused to:
cause the virtual agent to interact with the at least one approver to seek the one or more approvals if it is determined that one or more approvals are required for resolving the user request, wherein the at least one approver is provided the context of the request by the virtual agent.

20. The computer program product as claimed in claim 16, wherein the electronic device is further caused to:
connect with one or more service applications to effect automatic execution of the set of pre-determined actions, wherein each action is executed by the system or a service application from among the one or more service applications for facilitating resolution of the user request; and
log an entry corresponding to each executed action for meeting at least one of compliance and audit requirements.
